(19) United States
(12) Patent Application Publication
(10) Pub. No.: US 2026/0054532 A1
(43) Pub. Date: Feb. 26, 2026

(54) HOLLOW TIRE WITH INFLATING VALVE

(71) Applicant: Sichuan Yuanxing Rubber Co., Ltd., Chengdu (CN)

(72) Inventors: Jinggen GU, Chengdu (CN); Yang ZHANG, Chengdu (CN); Wei MENG, Chengdu (CN)

(73) Assignee: Sichuan Yuanxing Rubber Co., Ltd., Chengdu (CN)

(21) Appl. No.: 19/274,812

(22) Filed: Jul. 21, 2025

(30) Foreign Application Priority Data
Aug. 22, 2024 (CN) 2024111608387

(51) Int. Cl. B60C 29/04

(52) U.S. Cl. CPC B60C 29/04

(57) ABSTRACT

Disclosed is a hollow tire with an inflating valve, including two parts: a tire body and an inflating valve. The inflating valve is disposed in the tire body, the inflating valve is a rubber gasket inflating valve, and an inflating valve rubber base and the tire body of the hollow tire are bonded by using a rubber vulcanization process to ensure gas tightness. An inflating valve body is hidden in the tire body of the hollow tire and can be located at any position on a cross section of the tire body of the hollow tire. Compared with an ordinary hollow tire, in this disclosure, the inflating valve is disposed on the hollow tire, so that high-pressure gas can be inflated, thereby enhancing a load-bearing capability and buffering performance and improving a service life of the tire.

### CROSS-REFERENCE TO RELATED APPLICATIONS

The application claims priority to Chinese patent application No. 2024111608387, filed on Aug. 22, 2024, the entire contents of which are incorporated herein by reference.

### TECHNICAL FIELD

This disclosure relates to the field of tires, and in particular, to a hollow tire with an inflating valve.

### BACKGROUND

Tires are grounding rolling elastic rubber products equipped on various vehicles or machinery, which have the functions of bearing loads, buffering road impacts, achieving contact with the road surface, and providing driving and braking forces. Since tires are subjected to various deformations, loads, forces, and high and low temperatures during driving, the tires must have high load-bearing performance, traction performance, and buffering performance.

Since Dunlop invented the pneumatic tire more than 100 years ago, tire technology has been continuously developing. Traditional pneumatic tires are supported by high-pressure air, have very good comfort and buffering properties, and are suitable for high-speed driving, but have the disadvantages of being easily punctured and pierced and requiring timely inflation due to slow gas leakage.

In recent years, with the development of slow and short-distance travel vehicles such as electric bicycles and scooters, especially shared electric vehicles and shared bicycles, due to poor use environments, some vehicles use solid tires, hollow tires, and other non-pneumatic tires to avoid puncture and leakage problems. Since these types of tires have no air support, various deformations and loads that the tire bears while driving are borne by the tire body material, which can easily damage the tires. If the load-bearing capability needs to be increased, stronger and harder tire bodies are needed. In this way, the comfort of the tires will become very poor, and the tires will become heavier. To meet regulatory requirements or have longer mileage, electric bicycles, shared electric bicycles, and other vehicles have lightweight design requirements, and the weight of the tires and the design of the vehicle body sizes are strictly controlled. In view of the fact that it is difficult to take into account the above performance requirements with the prior art, it is necessary to improve the tire structure and invent a tire that takes into account load-bearing properties, comfort, endurance, and convenient maintenance.

### SUMMARY

A purpose of this disclosure is to provide a hollow tire with an inflating valve to solve the above problem. By inflating the hollow tire with high-pressure air, a load-bearing capability is improved, so that hardness and strength of a tire body of the hollow tire can be reduced, thereby improving comfort and a service life of the tire.

This disclosure implements the above purpose through the following technical solution:

This disclosure provides a hollow tire with an inflating valve, including two parts: a tire body and an inflating valve, where the inflating valve is disposed in the tire body.

Preferably, in this disclosure, a shape of the tire body may be various cross-sectional shapes, the cross-sectional shape is provided with an inner hole, and the tire body may be an outer tire with a pattern that is in direct contact with a road surface for use or may be an inner tire without a pattern.

Preferably, in this disclosure, one, two, or more inner holes may be provided.

Preferably, in this disclosure, to ensure gas tightness and piercing resistance performance, a thickness of an outer wall is not less than 5 mm.

Preferably, in this disclosure, the inflating valve is a rubber gasket inflating valve and includes an inflating valve rubber base, an inflating valve body, and a valve core, the inflating valve rubber base and the tire body of the hollow tire are bonded by using a rubber vulcanization process to ensure the gas tightness, and the inflating valve body is hidden in the tire body of the hollow tire and can be located at any position on a cross section of the tire body of the hollow tire.

Beneficial effects of this disclosure are as follows: Compared with an ordinary hollow tire, in this disclosure, the inflating valve is disposed on the hollow tire, so that high-pressure gas can be inflated, thereby enhancing a load-bearing capability and buffering performance and improving a service life of the tire. At the same time, the gas tightness and piercing resistance performance are ensured through a material thickness of the tire body, to avoid piercing and gas leakage during use, thereby achieving a purpose of a maintenance-free hollow tire. In addition, since the inflating valve is internally disposed, an appearance of the hollow tire is the same as that of the ordinary hollow tire, which does not affect assembling.

### BRIEF DESCRIPTION OF THE DRAWINGS

FIG. 1 is a schematic structural diagram of a hollow tire with an inflating valve according to this disclosure;

FIG. 2 is a schematic diagram 1 of a cross-sectional structure along A-A according to this disclosure;

FIG. 3 is a schematic diagram 2 of a cross-sectional structure along A-A according to this disclosure;

FIG. 4 is a schematic diagram 3 of a cross-sectional structure along A-A according to this disclosure;

FIG. 5 is a schematic diagram of a cross-sectional structure of a valve core in a hollow tire with an inflating valve according to this disclosure; and

FIG. 6 is a schematic diagram of a cross-sectional structure of an inflating valve in a hollow tire with an inflating valve according to this disclosure.

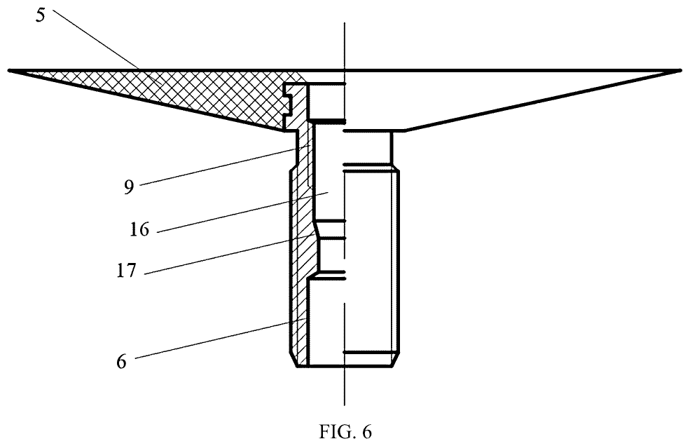

In the figures: 1. tire body; 2. inflating valve; 3. inner hole; 4. outer wall; 5. inflating valve rubber base; 6. inflating valve body; 7. valve core; 8. core rod; 9. assembling thread; 10. core cap; 11. sealing ring; 12. spring; 13. core body; 14. sealing gasket; 15. core base; 16. inflating valve core cavity; 17. sealing inclined surface.

### DETAILED DESCRIPTION OF THE EMBODIMENTS

To make the purposes, technical solutions, and advantages of this disclosure clearer, the implementation method of this disclosure will be described in detail below with reference to the accompanying drawings and embodiments, so that the implementation process of how this disclosure applies technical means to solve technical problems and achieve technical effects can be fully understood and implemented accordingly.

Many specific details are elaborated in the following description to facilitate a full understanding of this disclosure. However, this disclosure can also be implemented in other ways different from those described herein. Therefore, the scope of protection of this disclosure is not limited by the specific embodiments disclosed below.

Specific embodiments of this disclosure are described in detail below with reference to the accompanying drawings.

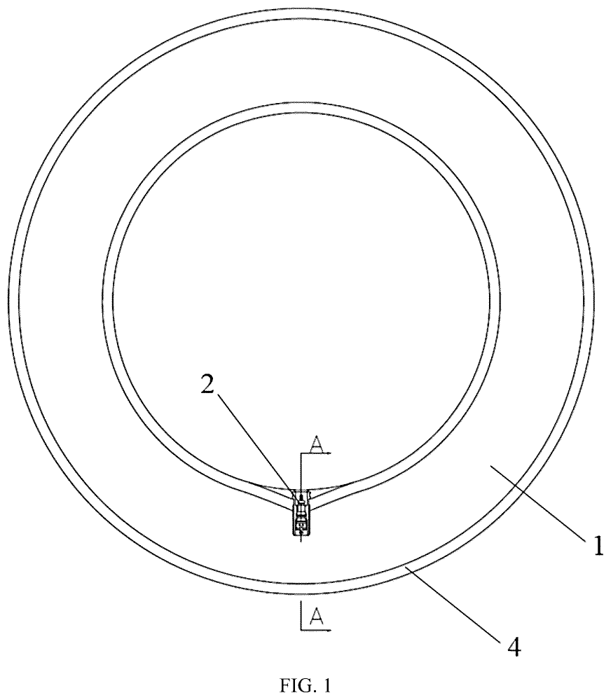

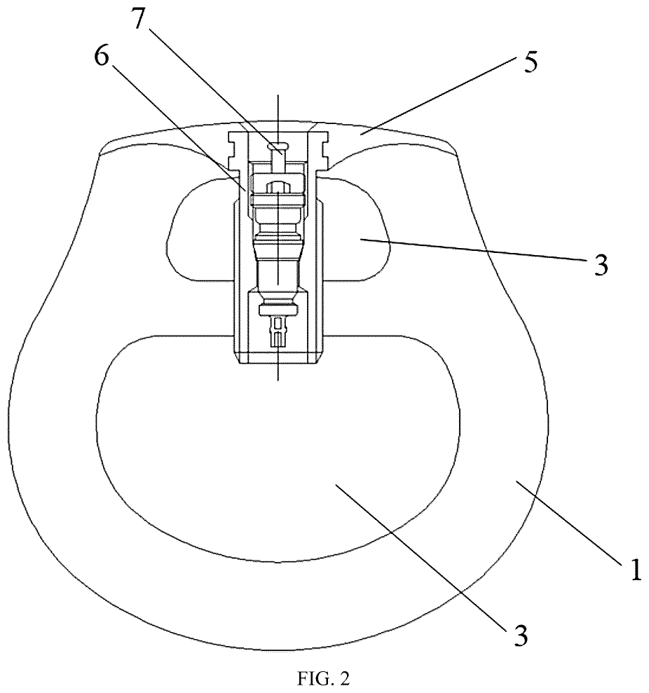

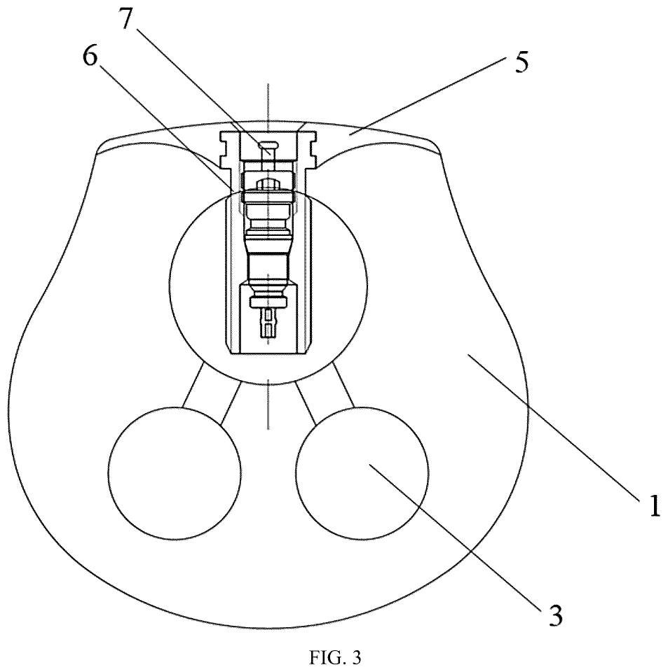

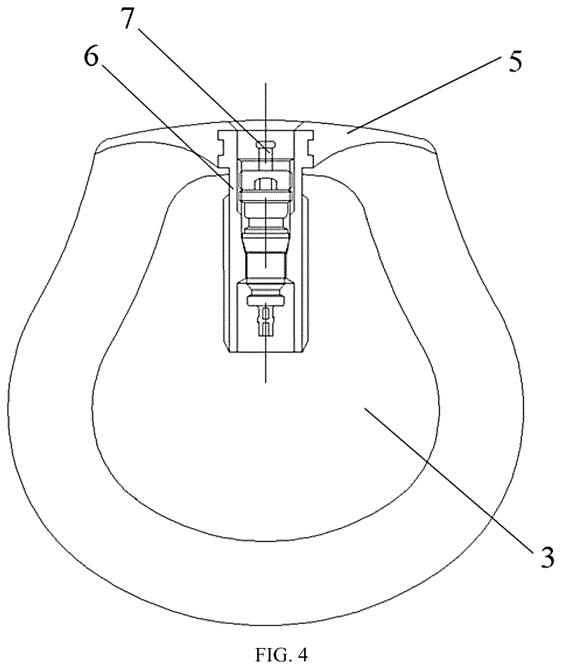

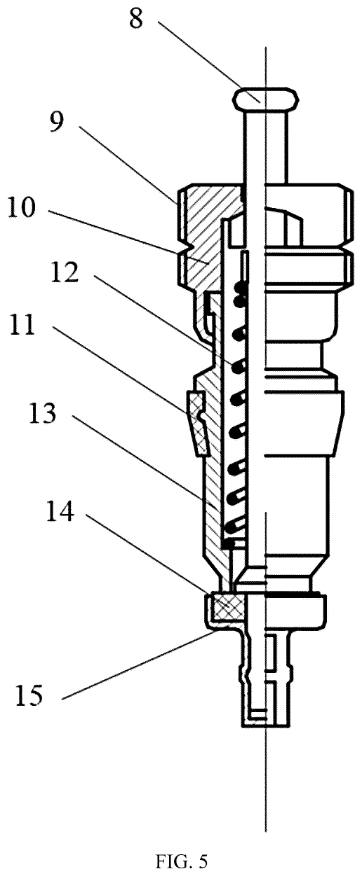

As shown in FIG. 1 to FIG. 5, an embodiment provides a hollow tire with an inflating valve, including two parts: a tire body 1 and an inflating valve 2. The inflating valve 2 is disposed in the tire body 1, and a shape of the tire body 1 may be various cross-sectional shapes. The cross-sectional shape is provided with an inner hole 3, and the tire body 1 may be an outer tire with a pattern that is in direct contact with a road surface for use or may be an inner tire without a pattern. The inner hole 3 is mainly used for shock absorption, weight reduction, comfort improvement, and energy consumption reduction. According to a vehicle load, a speed, a use environment, and other design requirements, one, two, or more inner holes may be provided.

Preferably, in the embodiment of this disclosure, to ensure gas tightness and piercing resistance performance, the thickness of an outer wall 4 is not less than 5 mm. The tire body 1 is made of vulcanized rubber with a formula using high cis-polybutadiene rubber, natural rubber, trans-isoprene rubber, and brominated butyl rubber. At the same time, a reinforcing agent adopts a polyester fiber for reinforcing. Therefore, a rubber material has performance of low heat generation, good fatigue resistance, high hardness, good support, good gas retention, and the like. The gas tightness is tested according to GB/T1038. Compared with an ordinary hollow tire, an actual detected gas permeability coefficient of a material of the tire body in this disclosure is 3.08×10⁻¹³ cm³·cm/cm²·s·Pa, while gas permeability of ordinary rubber is 5.71×10⁻¹³ cm³·cm/cm²·s·Pa. The gas permeability is reduced by 46%, so that good gas tightness may be provided, and frequent maintenance is not needed.

Preferably, in the embodiment of this disclosure, the inflating valve 2 is a rubber gasket inflating valve and includes an inflating valve rubber base 5, an inflating valve body 6, and a valve core 7. The inflating valve rubber base 5 and the tire body 1 of the hollow tire are bonded by using a rubber vulcanization process to ensure the gas tightness. The inflating valve body 6 is hidden in the tire body of the hollow tire and can be located at any position on a cross section of the tire body of the hollow tire. The valve core 7 is disposed in the inflating valve body 6.

Preferably, in the embodiment of this disclosure, the valve core 7 includes a core rod 8, an assembling thread 9, a core cap 10, a sealing ring 11, a spring 12, a core body 13, a sealing gasket 14, and a core base 15. The core rod 8 is provided with the spring 12, the core cap 10 is provided with the assembling thread 9, the core body 13 is provided with the sealing ring 11, and the core base 15 is provided with the sealing gasket 14. The inflating valve body 6 is hollow, and a hollow portion is referred to as an inflating valve core cavity 16. The inflating valve core cavity 16 is provided with the assembling thread 9 and a sealing inclined surface 17 that are matched with the valve core 7. The core rod 8 faces one end of the inflating valve rubber base 5, the core base 15 faces one end of the inflating valve body 6, and one side of an inclined surface of the inflating valve rubber base 5 is attached to the tire body 1 of the hollow tire. The inflating valve rubber base 5 and the inflating valve body 6 are bonded into a whole by using the rubber vulcanization process to ensure the gas tightness.

Compared with an ordinary inflating valve, in this disclosure, the core rod 8 of the valve core faces one end of the inflating valve rubber base 5, the core base 15 of the valve core faces one end of the inflating valve body 6, and one side of the inclined surface of the inflating valve rubber base 5 is attached to the tire body 1 of the hollow tire. The inflating valve body 6 is completely disposed in the tire body 1 of the hollow tire, and the inflating valve 2 and the tire body 1 of the hollow tire are bonded into a whole by using the rubber vulcanization process to ensure the gas tightness. In the ordinary inflating valve, the core rod of the valve core faces one end of the inflating valve body, and the core base of the valve core faces one end of the inflating valve rubber base. During use, a bottom plane of the inflating valve rubber base is attached to the tire body of the hollow tire, and the inflating valve protrudes from the tire body of the hollow tire. When designing wheel rim and vehicle structures, it is necessary to consider an impact of a position of the inflating valve body and to process a corresponding inflating valve hole on the wheel rim, thereby avoiding collision with the inflating valve protruding from the wheel rim when a vehicle wheel rotates.

### Product Experimental Results:

### 1. Vehicle Wheel/Tire Assembly High-Speed Test

The test is performed according to Section 5.4 of GBT13203-2014, and the drum diameter of a tester is 1700±17 mm. The tire should be mounted on a hub corresponding to an actual vehicle model for the test and loaded according to a tire specification. In a pre-test stage, a running speed is 40 km/h, running time is 120 min, and a specified speed needs to be reached within 5 min. After the pre-test stage is completed, the test is conducted by gradually accelerating after the tire is cooled down to 38±3° C. Stage 1: a running speed is 50 km/h, and running time is 60 min; Stage 2: a running speed is 60 km/h, and running time is 60 min; and Stage 3: a running speed is 70 km/h, and running time is 60 min. Time for changing the speed in each stage shall not exceed 1 min (excluding the pre-test stage). After the test, there shall be no tire falling off, hub breakage, visible cracks, and internal cracking or internal burning of the tire.

### 2. Vehicle Wheel/Tire Assembly Fatigue Test

The test is performed according to Section 4.1 of ISO 4210-7. With the load applied according to the tire specification. An obstacle block is hit 1,000,000 times at a speed of 25 km/h (±10%). After the test, there should be no tire falling off, vehicle wheel breakage, and visible cracks, and no internal cracking or internal burning, or other abnormal phenomena when the tire is cut.

In an example of 16×2.50 tire specification product verification, in comparison of high-speed and fatigue tests with a load of 150 kg, a product weighing 2420 g in the prior art is not damaged after the high-speed and fatigue tests, but a product weighing 2250 g in the prior art has an internal burning phenomenon after the high-speed and fatigue tests. A product weighing 2230 g in this disclosure is not damaged after the high-speed and fatigue tests. It can be seen that the products in the prior art need to meet the performance requirements by increasing materials and improving the hardness of the tire body, which may reduce comfort and increase costs at the same time. Compared with the prior art, the product in this disclosure has significant advantages and can achieve better performance, featuring low heat generation, good fatigue resistance, high hardness, good support, and good gas retention under the same conditions.

Although this disclosure is described herein with reference to the illustrative embodiments of this disclosure, the above embodiments are only preferred embodiments of this disclosure, and the embodiments of this disclosure are not limited to the above embodiments. It should be understood that a person skilled in the art can design many other modifications and embodiments, which will fall within the scope and spirit of the principles disclosed in this disclosure.

What is claimed is:

1. A hollow tire with an inflating valve, comprising two parts: a tire body (1) and an inflating valve (2), wherein the inflating valve (2) is disposed in the tire body (1).

2. The hollow tire with an inflating valve according to claim 1, wherein the tire body (1) is provided with an inner hole (3).

3. The hollow tire with an inflating valve according to claim 1, wherein the tire body (1) is an outer tire with a pattern or an inner tire without a pattern.

4. The hollow tire with an inflating valve according to claim 2, wherein one, two, or more inner holes (3) are provided.

5. The hollow tire with an inflating valve according to claim 1, wherein a thickness of an outer wall (4) of the tire body (1) is not less than 5 mm.

6. The hollow tire with an inflating valve according to claim 1, wherein the inflating valve (2) is a rubber gasket inflating valve and comprises an inflating valve rubber base (5), an inflating valve body (6), and a valve core (7), the inflating valve rubber base (5) and the tire body (1) of the hollow tire are bonded by using a rubber vulcanization process, the inflating valve body (6) is hidden in the tire body (1) of the hollow tire, and the valve core (7) is disposed in the inflating valve body (6).

7. The hollow tire with an inflating valve according to claim 6, wherein the valve core (7) comprises a core rod (8), an assembling thread (9), a core cap (10), a sealing ring (11), a spring (12), a core body (13), a sealing gasket (14), and a core base (15), the core rod (8) is provided with the spring (12), the core cap (10) is provided with the assembling thread (9), the core body (13) is provided with the sealing ring (11), and the core base (15) is provided with the sealing gasket (14).

8. The hollow tire with an inflating valve according to claim 7, wherein the inflating valve body (6) is hollow, a hollow portion is referred to as an inflating valve core cavity (16), the inflating valve core cavity (16) is provided with the assembling thread (9) and a sealing inclined surface (17) that are matched with the valve core (7), the core rod (8) faces one end of the inflating valve rubber base (5), the core base (15) faces one end of the inflating valve body (6), and one side of an inclined surface of the inflating valve rubber base (5) is attached to the tire body (1).

9. The hollow tire with an inflating valve according to claim 1, wherein the tire body (1) is made of vulcanized rubber with components comprising high cis-polybutadiene rubber, natural rubber, trans-isoprene rubber, brominated butyl rubber, and a reinforcing agent, and the reinforcing agent adopts a polyester fiber.

10. The hollow tire with an inflating valve according to claim 9, wherein a gas permeability coefficient of a material of the tire body (1) is not greater than 3.5×10⁻¹³ cm³·cm/cm²·s·Pa.
